(19) United States
(12) Patent Application Publication
(10) Pub. No.: US 2008/0210065 A1
(43) Pub. Date: Sep. 4, 2008

(54) Method For Cutting Lead Terminal Of Packaged Electronic Component

(75) Inventors: Masahiro Noda, Kyoto (JP); Masahiko Kobayakawa, Kyoto (JP); Tadatoshi Miwa, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto-shi (JP)

(21) Appl. No.: 11/795,663

(22) PCT Filed: Jan. 18, 2006
(86) PCT No.: PCT/JP06/00619

§ 371 Date: Jul. 19, 2007

(30) Foreign Application Priority Data
Jan. 21, 2005 (JP) 2005-014351

(51) Int. Cl. B26D 7/08

(52) U.S. Cl. 83/14

(57) ABSTRACT

A method for cutting a lead terminal of a packaged electronic component including a resin package (5), an element (2) covered by the package (5), and a lead terminal (3) connected to the element (2) and including a protruding portion extending out of the package (5). The method includes the steps of forming a narrow bridge portion (23) at the lead terminal (3) by removing a part of the protruding portion, providing a metal plate to the protruding portion of the lead terminal (3), and cutting the lead terminal (3) at the narrow bridge portion (23).

### TECHNICAL FIELD

The present invention relates to a manufacturing method of an electronic component including a resin package. In particular, the present invention relates to a cutting method of a lead terminal protruding from the resin package. Examples of the electronic component include a capacitor and a semiconductor integrated circuit.

### BACKGROUND ART

The patent document 1 listed below discloses a solid electrolytic capacitor as an example of a packaged electronic component. The solid electrolytic capacitor includes a package made of a thermosetting synthetic resin and an anode lead terminal and a cathode lead terminal protruding from the package. The package accommodates a capacitor element. The capacitor element includes a chip made of a metal material providing valve-action (simply referred to as “valve-action metal” hereinafter), an anode bar protruding from one end surface of the chip, and a cathode film formed on the chip. The anode bar and the cathode film are connected to the anode lead terminal and the cathode lead terminal, respectively.

The above conventional solid electrolytic capacitor is made as follows. First, a lead frame having a predetermined pattern is prepared. The lead frame includes two supporting rails extending parallel to each other, and pairs of lead terminals (anode lead terminals and cathode lead terminals) provided between the supporting rails. Each pair of the anode lead terminal and the cathode lead terminal is positioned to face to each other. By providing plating to the anode lead terminal and the cathode lead terminal, a metal plate layer (solder plate layer, for example) is formed.

Next, the capacitor element is positioned between the anode lead terminal and the corresponding cathode lead terminal. Here, the anode bar and the cathode film are fixed in electrical connection to the anode lead terminal and the cathode lead terminal, respectively. Then, the whole capacitor element is sealed by the resin package.

Finally, the lead terminals protruding from the package are cut. The cutting process is performed utilizing a vertically movable cutting punch. In this way, a solid electrolytic capacitor is separated from the supporting rails.

In mounting the above solid electrolytic capacitor to a printed circuit substrate, the lead terminals protruding from the package are soldered to the printed circuit substrate.

According to the above conventional art, the lead terminal, provided in advance with the solder plate layer, is cut by a cutting punch. Thus, the tip end surface, or the surface cut by the punch, of the lead terminal is not covered by the solder plating layer. As a result, solder may not stick to the tip end surface of the lead terminal, so that the solid electrolytic capacitor is not mounted on the printed circuit substrate firmly enough.

Patent Document: JP-A-2004-172527

### DISCLOSURE OF THE INVENTION

An object of the present invention is to provide a cutting method of a lead terminal of a packaged electronic component to solve the above-described problem.

According to the present invention, there is provided a method for cutting a lead terminal of a packaged electronic component comprising a resin package, an element covered by the package, and a lead terminal connected to the element, the lead terminal including a protruding portion extending out of the package. The method comprises the steps of forming a narrow bridge portion at the lead terminal by removing a part of the protruding portion, providing a metal plate to the protruding portion, and cutting the lead terminal at the narrow bridge portion.

The narrow bridge portion is provided by forming a cutout or a through-hole at the protruding portion of the lead terminal.

According to the above method, after forming the narrow bridge portion at the lead terminal by removing a part of the protruding portion of the lead terminal, metal plate is provided to the protruding portion. Then, the lead terminal is cut at the narrow bridge portion. In this way, the lead terminal is provided with the metal plate layer not only at the upper surface, the lower surface, and two side surfaces, but also at a part of the tip end surface.

With such structure, in mounting the packaged capacitor to a printed circuit substrate, the solder wettability at the tip end surface of the lead terminal is enhanced. This is advantageous in that the capacitor is mounted to the printed circuit substrate firmly.

Further, since there is no need to perform additional step for providing a metal plate layer to the tip end surface of the lead terminal after cutting the lead terminal, the product cost is reduced.

Preferably, the cutting step of the lead terminal is performed by using a cutting member and a supporting die. The cutting member includes a cutting portion brought into contact with the lead terminal, and a non-cutting portion prevented from contacting the lead terminal. The cutting portion may protrude toward the package relative to the non-cutting portion. Such structure can be obtained by forming a recess at the cutting surface of the cutting member. By using such cutting member, a region provided with the metal plate layer is left at the tip end of the lead terminal of the finally-obtained packaged electronic component.

According to the present invention, the narrow bridge portion is cut at a portion most closely to the package, for example. In this way, the tip end surface of the lead terminal after the cutting step can be a flat surface, in which a cut surface (where the lead terminal is partly exposed) is flush with a covered surface (provided with the metal plate layer) In other words, no unevenness or irregularity exists at the tip end surface of the lead terminal. As a result, the metal plate layer covering the tip end surface of the lead terminal blends well with solder paste provided to a printed circuit substrate.

### BRIEF DESCRIPTION OF THE DRAWINGS

FIG. 1 is a sectional view illustrating a solid electrolytic capacitor made by a method according to a first embodiment of the present invention.

FIG. 2 is a perspective view illustrating the bottom side of the solid electrolytic capacitor of FIG. 1.

FIG. 3 is a perspective view illustrating a lead frame used for manufacturing the solid electrolytic capacitor of FIG. 1.

FIG. 4A is a partial sectional view illustrating the method according to the first embodiment of the present invention. FIG. 4B is a sectional view taken along lines IVb-IVb of FIG. 4A.

FIG. 5 is a sectional view illustrating a method according to a second embodiment of the present invention, corresponding to FIG. 4B.

FIG. 6 is a sectional view illustrating a method according to a third embodiment of the present invention, corresponding to FIG. 4B.

### BEST MODE FOR CARRYING OUT THE INVENTION

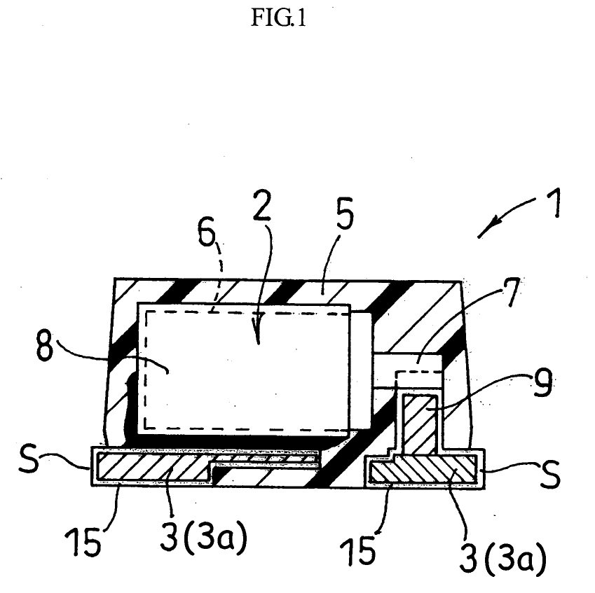

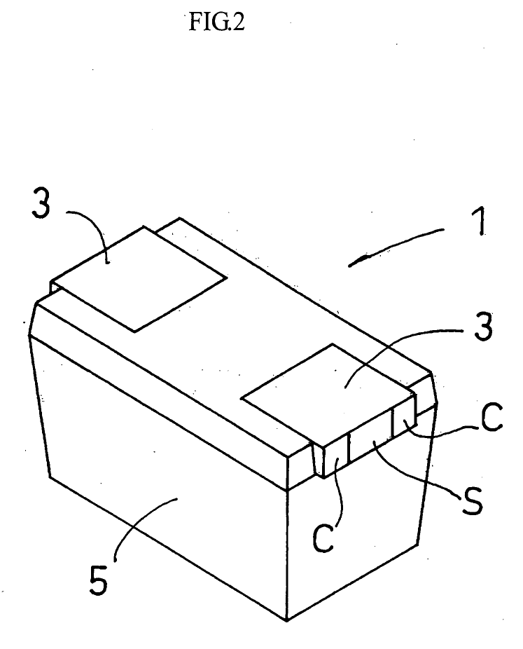

First, a method according to a first embodiment of the present invention is described with reference to FIGS. 1-4B. FIGS. 1 and 2 schematically illustrate a packaged electronic component made by the present method. The illustrated electronic component is a solid electrolytic capacitor which is only an example, and the present invention is not limited to be used for solid electrolytic capacitors.

As shown in FIG. 1, the solid electrolytic capacitor 1 includes a capacitor element 2, a pair of lead terminals 3 (an anode lead terminal 3a and a cathode lead terminal 3b), and a package 5 made of a thermosetting synthetic resin. The lead terminals are made of a metal plate. The package 5 seals the whole capacitor element 2. Each of the lead terminals 3 is partly covered by the package 5, and partly exposed out of the package 5 (see FIG. 2). The lead terminals 3 extend out of the resin package 5 in the horizontal direction.

The capacitor element 2 includes a chip 6 and an anode bar 7 extending from one end surface (at the right side in FIG. 1) of the chip. The chip 6 is a porous body made by sintering powder of a valve-action metal such as tantalum. Similarly, the anode bar 7 is also made of a valve-action metal. Though not shown, on the chip 6, a dielectric layer having a high electrical insulating property is formed. Further, on the chip 6 (precisely, on the dielectric layer) , a solid electrolytic layer is formed except at the right side end surface. Still further, on the solid electrolytic layer, cathode film 8 is formed.

As shown in FIG. 1, a vertical connecting portion 9 is welded to the anode lead terminal 3a. Such vertical portion may be formed by bending a part of the anode lead terminal 3a. The connecting portion 9 is fixed to the anode bar 7 of the capacitor element 2 by a conductive paste or a cream solder for electrical connection therebetween. The upper surface of the cathode lead terminal 3 is fixed to the cathode film 8 by a conductive paste, a cream solder, or welding for electrical connection therebetween.

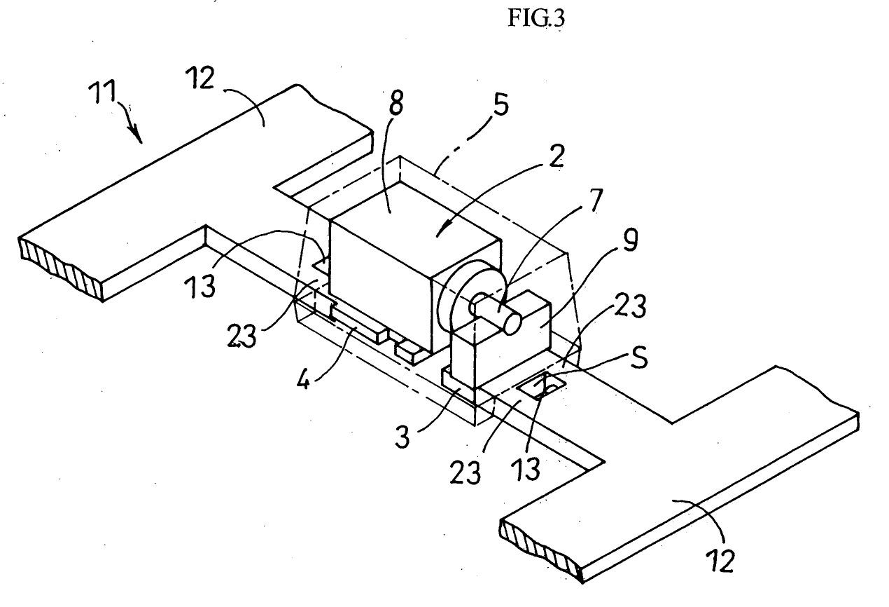

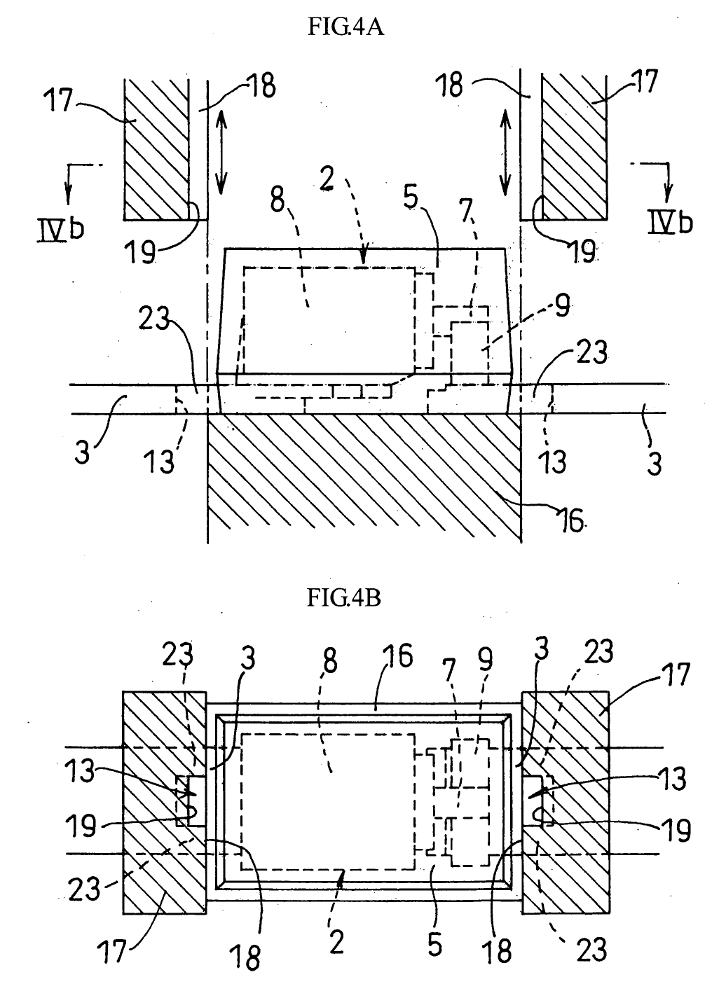

Here, an example of a manufacturing method of the above-described solid electrolytic capacitor is described with reference to FIGS. 3, 4A, and 4B.

First, punching process is performed to a metal plate to prepare a lead frame 11 as shown in FIG. 3. The lead frame 11 includes a pair of supporting rails 12 extending in parallel with each other, plural pairs of lead terminals 3 (anode lead terminals and cathode lead terminals), though only one pair of lead terminals 3 are shown in FIG. 3. Each pair of the lead terminals 3 is spaced from adjacent pair at a predetermined interval in the longitudinal direction of the supporting rails 12. Each of the lead terminals 3 extends from one of the supporting rails perpendicularly toward the other supporting rail, and faces the corresponding lead terminal 3. The lead terminal 3 is formed with a through-hole 13 vertically penetrating the terminal. As shown in FIG. 3, the through-hole 13 is positioned outside of the package 5 which is to be formed later. The through-hole 13 is sandwiched by a pair of narrow bridge portions 23.

Next, as shown in FIG. 3, the connecting portion 9 is welded in a vertical posture to a free end of the anode lead terminal 3. Such vertical connecting portion may be formed by bending the free end of the anode lead terminal 3. Thereafter, each the lead terminals 3 is subjected to metal plating, to form a base layer of nickel plating (not shown) and a metal plating layer 15 (see FIG. 1) with excellent solder wettability. The metal plating layer 15 is made of tin or solder, for example. Such metal plating may be provided to the whole or a part of the lead terminal 3. In the latter case, however, the plating needs to be provided to the lead terminal 3 at least at the portion protruding beyond the package 5. By providing the metal plating, the inner wall surfaces of the through-hole 13 are covered by the metal plating layer 15.

Then, as shown in FIG. 3, the capacitor element 2 is positioned between the paired lead terminals 3, so that the anode bar 7 is brought into contact with the connecting portion 9. The anode bar 7 is fixed to the connecting portion 9, and the cathode film 8 is fixed to the cathode lead terminal 3 by a conductive paste or a cream solder for electrical connection therebetween.

Next, the package 5 to cover the whole capacitor element 2 is formed. The package 5 can be formed by the following steps. First, a formwork (not shown) having a hollow portion of a predetermined size is placed on the lead frame 11. Here, the capacitor element 2 is accommodated within the form work. Then, a liquid thermosetting synthetic resin is filled in the hollow portion so that the capacitor element 2 is immersed completely. Finally, the resin is set to form the package 5. The above-described metal plating of the lead terminals 3 may be performed after the forming of the package. In this case, the base layer and the metal plating layer 15 are formed at the exposed portion (out of the package 5) of the lead terminal 3.

After the package 5 is formed, as shown in FIG. 4A, the package 5 is supported by a supporting die 16 from below. Then, a vertically movable cutting punch 17 is utilized to cut the narrow bridge portions 23 (cutting step). In this way, a completed product of the solid electrolytic capacitor 1 (see FIGS. 1 and 2) is cut off from the supporting rails 12.

As shown in FIG. 4B, each of the cutting punch 17 includes a cutting surface 18 formed with a recess 19 elongated in the vertical direction. In other words, the cutting punch 17 includes two cutting surfaces 18 separated by the recess 19, and the cutting surfaces 18 protrude from a non-cutting surface (the bottom surface of the recess 19) forward (toward the package 5). With such structure, a region S (See FIG. 2) provided with the metal plating layer 15 (and the base layer) can be left at the cut surface of the lead terminal 3. As can be seen from FIGS. 3 and 4B, the region S corresponds to one of the four inner wall surfaces of the through-hole 13, positioned at the side of the package 5. As shown in FIG. 2, the region S is a part of the tip end surface of the lead terminal 3, and sandwiched between exposed surfaces C (where the metal plate layer 15 is not provided).

When the cutting surfaces 18 of the cutting punch 17 cuts the lead terminal 3, the cutting surfaces 18 cut only the narrow bridge portions 23, without contacting the region S. For this, the width of the recess 19 (measured in the vertical direction in FIG. 4B) is set to be the same as or substantially the same as the width of the through-hole 13.

As shown in FIG. 2, the tip end surface of the lead terminal 3 cut off from the supporting rail 12 is a flat surface including two exposed surfaces C and the region S provided with the metal plating layer. In other words, the exposed surfaces C and the region S are flush with each other.

In mounting the solid electrolytic capacitor 1 to a printed circuit substrate, the paired lead terminals 3, protruding from the package 5 in the directions opposite to each other, are soldered to the printed circuit substrate.

According to the above-described method, after being cut off from the supporting rails 12, each of the lead terminals 3 is covered by the metal plating layer 15 not only at the upper surface, the lower surface, and two side surfaces, but also at a part of the tip end surface (region S).

With such structure, due to the region S, the solder wettability of the tip end surface is enhanced. Thus, in mounting the solder electrolytic capacitor 1 to a printed circuit substrate, in addition to the upper surface, the lower surface, and two side surfaces, the tip end surface can be used to fix the lead terminal 3 to the printed circuit substrate via solder. As a result, the solder electrolytic capacitor 1 can be mounted on the printed circuit substrate firmly.

Further, according to the above method, after the cutting step, there is no need to perform an additional step for forming the metal plating layer 15 on the tip end surface of the lead terminal 3.

As shown in FIG. 4B, the recess 19 of the cutting member 17 is formed at a position corresponding to the region S which exists between the cut surfaces (exposed surfaces C in FIG. 2) of the inner wall surface of the through-hole 13. Thus, when cutting by the cutting punch 17, the cutting surfaces 18 of the cutting punch 17 are prevented from contacting with and rubbing against the region S. Therefore, the metal plate layer 15 provided at the region S is reliably prevented from scraped off by the cutting punch 17. As a result, the yield of the solid electrolytic capacitor 1 can be increased.

Further, by cutting the narrow bridge portions 23 using the cutting punch 17 and the supporting die 16, the tip end surface of the lead terminal 3 can be a flat surface as shown in FIG. 2. With such structure, no irregularity exists in the vicinity of the metal plating layer 15 on the flat surface, so that the metal plating layer 15 on the tip end surface of the lead terminal 3 blends well with solder paste provided on a printed circuit substrate. As a result, the solder electrolytic capacitor 1 can be mounted on the printed circuit substrate firmly.

The through-hole 13 of the lead terminal 3 is sandwiched by the narrow bridge portions 23. The narrow bridge portions 23 prevent synthetic resin melted in the forming step of the package 5 from entering into the through-hole 13. Thus, after forming the package 5, there is no need to remove resin burr from the tip end surface of the lead terminal 3.

The through-hole 13 is formed at the lead terminal 3 before the forming step of the package 5. This reduces the area of the surface of the lead terminal 3 to be cut after forming the package 5. As a result, the impact of cutting can be reduced and thus an adverse effect on the adhesion between the lead terminal 3 and the package 5 can be prevented.

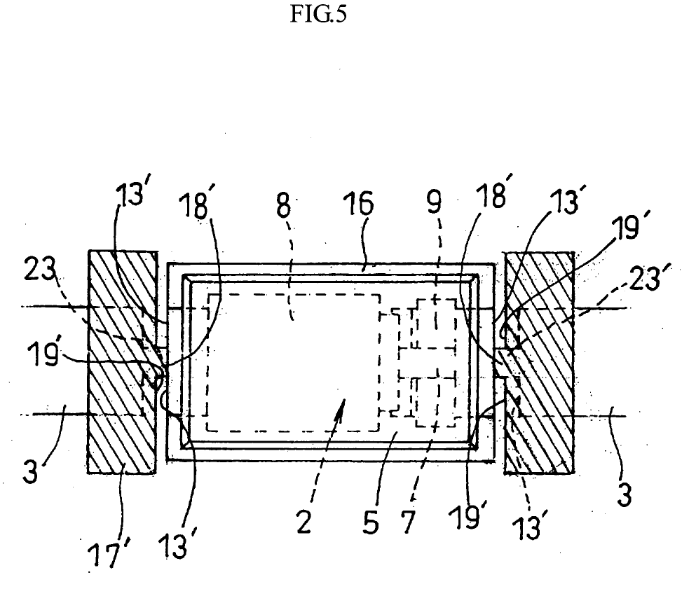

FIG. 5 illustrates a cutting method of the lead terminal according to a second embodiment of the present invention. In the present embodiment, each of the lead terminals of the lead frame includes only one narrow bridge portion (indicated by reference number 23′ in the figure). Such narrow portion is made by forming cutouts 13′ extending from side ends perpendicular to the longitudinal direction of the lead terminal 3. As can be seen from FIG. 5, the paired cutouts 13′ formed at the lead terminal 3 are positioned outside of the package 5. In the present invention, only one cutout may be formed at the lead terminal 3.

Similarly to the first embodiment, metal plating is provided to the lead terminal 3. The metal plating step may be performed before or after forming the package. After providing metal plating to the lead terminal 3, the package 5 is supported by the receiving die 16 from below, and the narrow bridge portion 23′ is cut by the vertically movable cutting members 17. The narrow bridge portion 23′ is cut at a portion near the package 5. In this way, a completed product of the solid electrolytic capacitor 1 is cut off from the supporting rails 12 of the lead frame 11.

In the second embodiment, each of the cutting punches 17′ is formed with a plurality of recesses 19′ (two in the figure). Thus, the cutting punch 17′ includes two non-cutting surfaces and a cutting surface 18′ sandwiched by the non-cutting surfaces. The cutting surface 18′ forwardly protrudes from the non-cutting surfaces. In cutting the lead terminal 3, the cutting surface 18′ of the cutting punch 17′ is prevented from contacting the inner wall surfaces (at the side of the package 5) of the cutouts 13′. For this, the width of the cutting surface 18′ (measured in the vertical direction in FIG. 5) is set to be the same or substantially the same as the narrow bridge portion 23′.

In the second embodiment, similarly to the first embodiment, the metal plate layer can be left at the tip end surface of the lead terminal 3, so that the solder electrolytic capacitor can be mounted on the printed circuit substrate firmly. In the second embodiment, the metal plate layer is left at two portions, spaced form each other, of the tip end surface of the lead terminal 3.

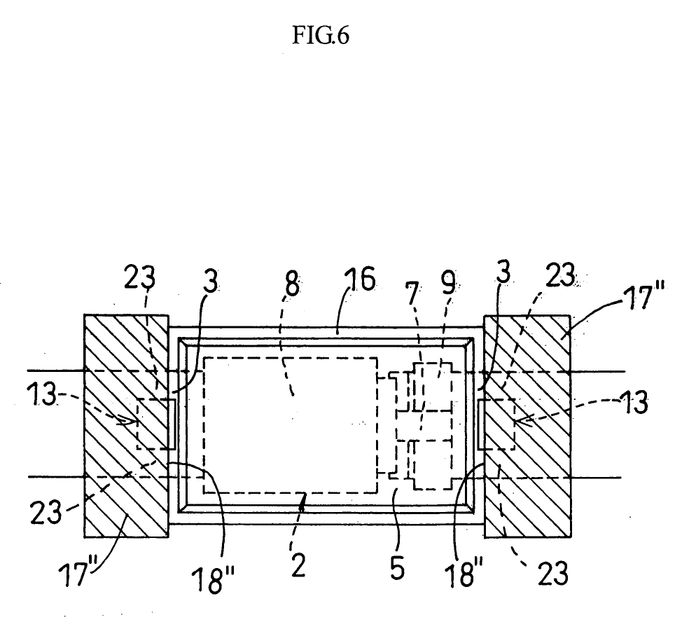

FIG. 6 illustrates a third embodiment of the present invention. Similarly to the first embodiment, the lead terminal 3 is formed with a through-hole 13. On the other hand, differently from the first embodiment, the cutting member 17″ of the third embodiment has an entirely flat cutting surface 18″, and has no recess. Even with such structure, when the cutting surface 18″ cuts the narrow bridge portions 23, cutting position can be set to prevent the cutting surface from contacting the inner wall surface of the through-hole 13 at the side of the package 5 (region S provided with the metal plate layer). In other words, as shown in FIG. 6, the cutting surface 18″ is deviated backward (away from the package 5) to be properly spaced from the inner wall surface of the through-hole 13.

Also in the third embodiment, the cut surfaces of the lead terminal 3 are substantially flush with the region S provided with the metal plating layer. Meanwhile, it is advantageous that a cutting member with a complicated shape is not required in the third embodiment.

The present invention is applied to electronic components including not only the above-described solid electrolytic capacitor, but also the one having no less than three lead terminals such as a transistor. The semiconductor chip and the lead terminals need not to be electrically connected directly, but may be connected by wire bonding using a fine metal wire, for example.

The structure of the components is not limited to the description described with reference to the drawings, but may be variously modified within the scope of the present invention.

1. A method for cutting a lead terminal of a packaged electronic component comprising a resin package, an element covered by the package, and a lead terminal connected to the element, the lead terminal including a protruding portion extending out of the package, the method comprising the steps of:
forming a narrow bridge portion at the lead terminal by removing a part of the protruding portion;
providing metal plating to the protruding portion; and
cutting the lead terminal at the narrow bridge portion.

2. The cutting method according to claim 1, wherein the narrow bridge portion is provided by forming a cutout at the protruding portion of the lead terminal.

3. The cutting method according to claim 1, wherein the narrow bridge portion is provided by forming a through-hole at the protruding portion of the lead terminal.

4. The cutting method according to claim 1, wherein the cutting step of the lead terminal is performed by using a cutting punch and a supporting die.

5. The cutting method according to claim 4, wherein the cutting punch includes a cutting portion brought into contact with the lead terminal, and a non-cutting portion kept out of contact with the lead terminal.

6. The cutting method according to claim 5, wherein the cutting portion protrudes toward the package relative to the non-cutting portion.
